(19) United States
(12) Patent Application Publication
(10) Pub. No.: US 2024/0190491 A1
(43) Pub. Date: Jun. 13, 2024

(54) MOBILE KITCHEN CART ASSEMBLY

(71) Applicant: Tryking Development Corporation, Kaohsiung City (TW)

(72) Inventor: MING-TSUNG TSAI, Kaohsiung City (TW)

(73) Assignee: Tryking Development Corporation, Kaohsiung City (TW)

(21) Appl. No.: 18/078,084

(22) Filed: Dec. 8, 2022

(51) Int. Cl. B62B 3/02; A47J 36/00; A47J 47/00

(52) U.S. Cl. CPC B62B 3/025; A47J 36/00; A47J 47/005

(57) ABSTRACT

A mobile kitchen cart assembly has a cart and two supporting stands respectively disposed at two sides of the cart. The cart includes a cart body, a cover plate, and multiple casters disposed at a bottom of the cart body. The cart body includes a carrier portion having an accommodating space and an operational portion located above the carrier portion and having an upper opening communicating with the accommodating space and a knife holder for holding knives. The cover plate covers the upper opening of the operational portion. The mobile kitchen cart assembly provides adequate operational space and a counter top at a suitable height by arrangement of the cart body with the cover plate and the two supporting stands.

### BACKGROUND OF THE INVENTION

### 1. Field of the Invention

The present invention relates to a mobile kitchen cart assembly, especially relates to a mobile kitchen cart assembly to allow a kitchen staff to prepare ingredients conveniently.

### 2. Description of Related Art

During cooking processes, ingredients are prepared, washed, and chopped. Then, the ingredients are cooked by being pan-fried, boiled, stir-fried, or deep-fired. To improve the efficiency of food preparation, in cooking environments such as kitchens of restaurants or caterings, the food preparation is carried out by team work of kitchen staffs. That is, some of the kitchen staffs are responsible for preparing ingredients and some of the kitchen staffs are responsible for cooking.

However, some of the cooking environments do not have enough space for preparing ingredients. To avoid interfering with the traffic flow of the kitchen staffs responsible for cooking, the ingredients are placed adjacent to a water source by those responsible for preparing ingredients to be cleaned or chopped. However, those kitchen staffs responsible for preparing ingredients have to squat at a vacant lot to clean or chop the ingredients for a period of time and therefore are prone to injuries of knees, shoulders, or backs for prolonged poor postures for a period of time.

To overcome the shortcomings, the present invention tends to provide a mobile kitchen cart assembly to mitigate or obviate the aforementioned problems.

### SUMMARY OF THE INVENTION

The main objective of the invention is to provide a mobile kitchen cart assembly to keep kitchen staffs from injuries due to prolonged poor postures while processing ingredients.

The mobile kitchen cart assembly comprises a cart and two supporting stands. The cart includes a cart body, a cover plate, and multiple casters. The cart body includes a carrier portion and an operational portion. The carrier portion has an accommodating space with a front opening facing toward a front of the cart body. The operational portion is located above the carrier portion and has an upper opening communicating with the accommodating space and a knife holder located at a rear of the operational portion. The cover plate is detachably disposed on and covers the upper opening of the operational portion. The multiple casters are disposed at a bottom of the cart body. The two supporting stands are respectively disposed at two sides of the cart body of the cart. Each of the two supporting stands includes a supporting plate being foldable and pivotally connected to the cart body of the cart and a supporting element being foldable and pivotally connected to the cart body of the cart, and connected to the supporting plate of the supporting stand to support the supporting plate in a horizontally expanding position.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a mobile kitchen cart assembly in accordance with the present invention;

FIG. 2 is another perspective view of the mobile kitchen cart assembly in FIG. 1;

FIG. 3 is a perspective view of the mobile kitchen cart assembly in FIG. 1 showing that one of two supporting stands of the mobile kitchen cart assembly is folded;

FIG. 4 is an exploded perspective view of the mobile kitchen cart assembly in FIG. 1 showing that a cover plate, a chopping board, and a storage box are included in the mobile kitchen cart assembly;

FIG. 5 is another exploded perspective view of the mobile kitchen cart assembly in FIG. 1 showing that a cover plate, multiple chopping boards, and a storage box are included in the mobile kitchen cart assembly;

FIG. 6 is a perspective view of a second embodiment of a mobile kitchen cart assembly in accordance with the present invention;

FIG. 7 is an operational perspective view of the mobile kitchen cart assembly in FIG. 6 showing that a heating device, two chopping boards, and multiple storage boxes are included in the mobile kitchen cart assembly;

FIG. 8 is an operational perspective view of the mobile kitchen cart assembly in FIG. 1 showing that the two supporting stands are folded;

FIG. 9 is an operational perspective view of the mobile kitchen cart assembly in FIG. 1 showing that food ingredients are processed; and

FIG. 10 is another operational perspective view of the mobile kitchen cart assembly in FIG. 1 showing that food ingredients are processed.

### DETAILED DESCRIPTION OF PREFERRED EMBODIMENT

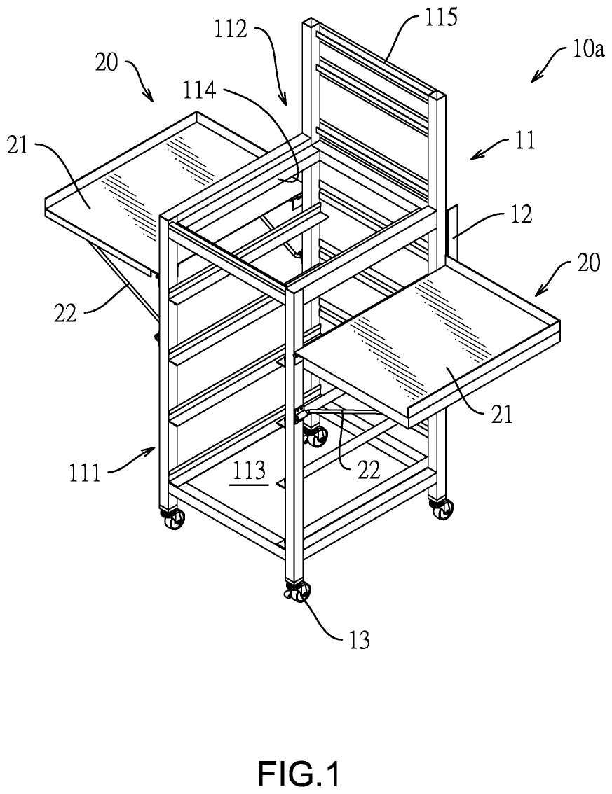

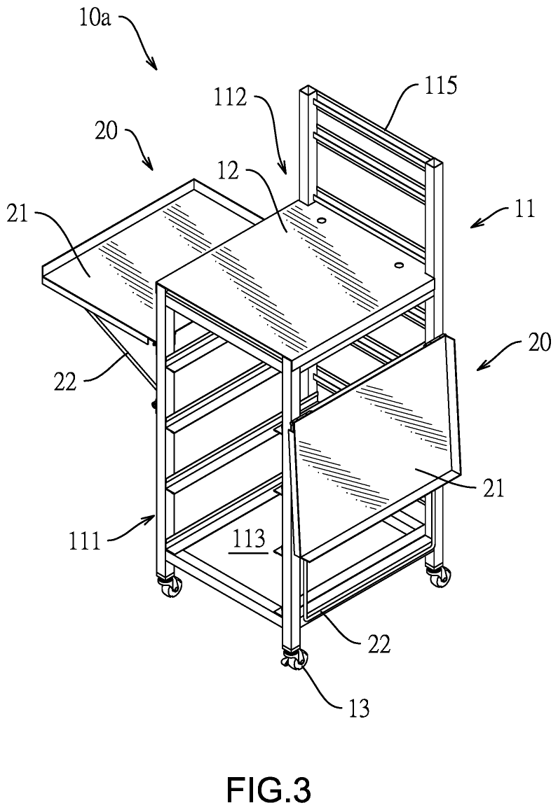

With reference to FIGS. 1 to 3, a first embodiment of a mobile kitchen cart assembly in accordance with the present invention comprises a cart 10a and two supporting stands 20.

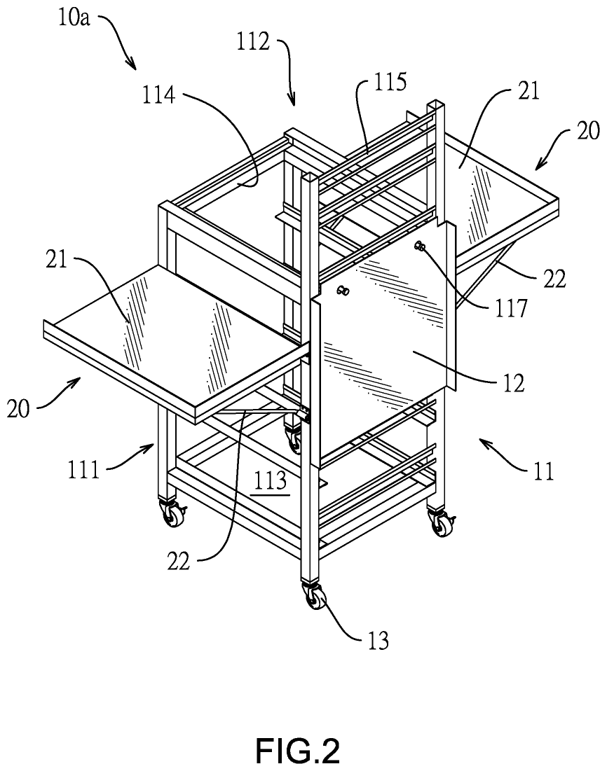

With reference to FIGS. 1 to 3, the cart 10a includes a cart body 11, a cover plate 12, and multiple casters 13. The cart body 11 includes a carrier portion 111 and an operational portion 112 located above the carrier portion 111. The carrier portion 111 has an accommodating space 113 with a front opening facing toward a front of the cart body 11. The operational portion 112 has an upper opening 114 communicating with the accommodating space 113 of the carrier portion 111 and a knife holder 115 located at a rear of the operational portion 112 and extending upwardly from the operational portion 112. The cover plate 12 is detachably disposed on and covers the upper opening 114. The casters 13 are disposed at a bottom of the cart body 11. As shown in FIG. 2, multiple hangers 117 are disposed on and protrude from an upper section of a rear of the cart body 11. The cover plate 12 can be hung on the rear of the cart body 11 via the multiple hangers 117.

With reference to FIGS. 1 to 3, the two supporting stands 20 are respectively disposed at two sides of the cart body 11. Each supporting stand is spaced apart from and located lower than the upper opening 114 of the operational portion 112 and is pivotally connected to the cart body 11 and is foldable. Each supporting stand 20 includes a supporting plate 21 and a supporting element 22. The supporting plate 21 and the supporting element 22 are foldably and pivotally connected to the cart body 11 of the cart 10a. The supporting element 22 is located below the supporting plate 21 and is connected to the supporting plate 21 to support the supporting plate 21 in a horizontally expanding position.

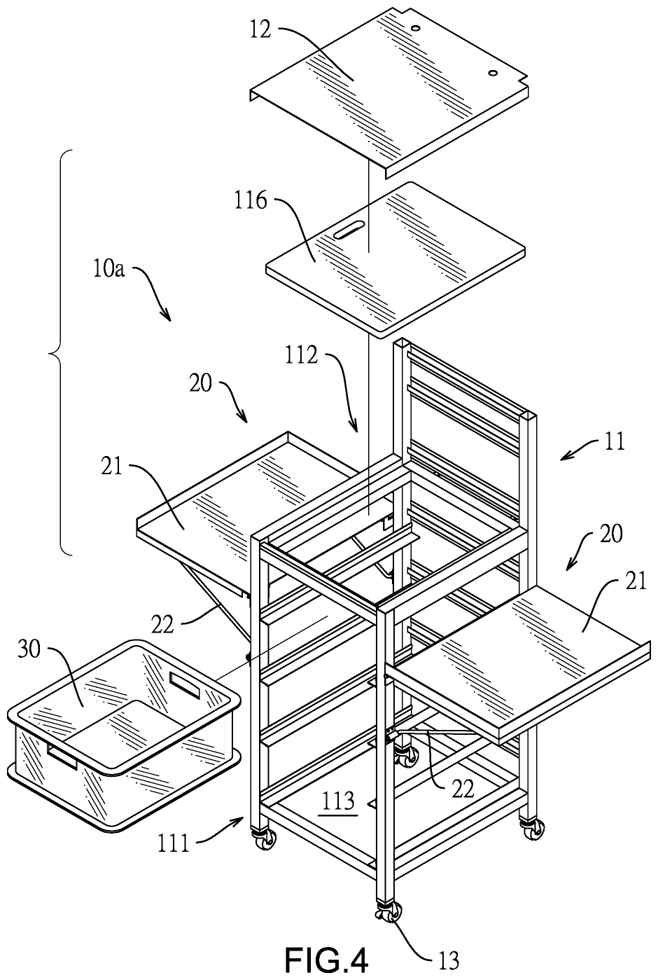

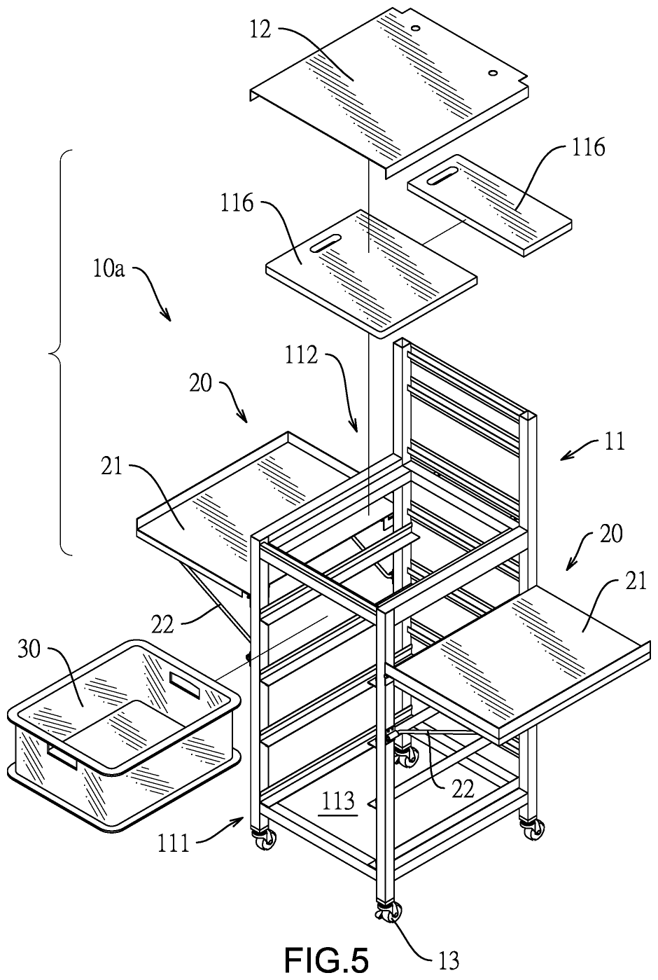

With reference to FIGS. 4 and 5, a chopping board 116 may be detachably disposed in the upper opening 114 of the operational portion 112 of the cart body 11. An amount of the chopping board 116 may be selected according to a kitchen staff's demand. For example, as shown in FIG. 4, the mobile kitchen cart assembly comprises one said chopping board 116. The chopping board 116 is detachably placed in the upper opening 114 of the operational portion 112. The cover plate 12 is configured to cover the upper opening 114 and the chopping board 116. As shown in FIG. 5, the mobile kitchen cart assembly comprises two chopping boards 116. The two chopping boards 116 are detachably disposed in the upper opening 114 of the operational portion 112, are arranged side by side, and are covered by the cover plate 12.

With reference to FIGS. 4 and 5, the mobile kitchen cart assembly may comprise multiple storage boxes 30. The storage boxes 30 are configured to be stored in the accommodating space 113. The storage boxes 30 are configured to carry or store ingredients 60 according to the demands of the kitchen staff.

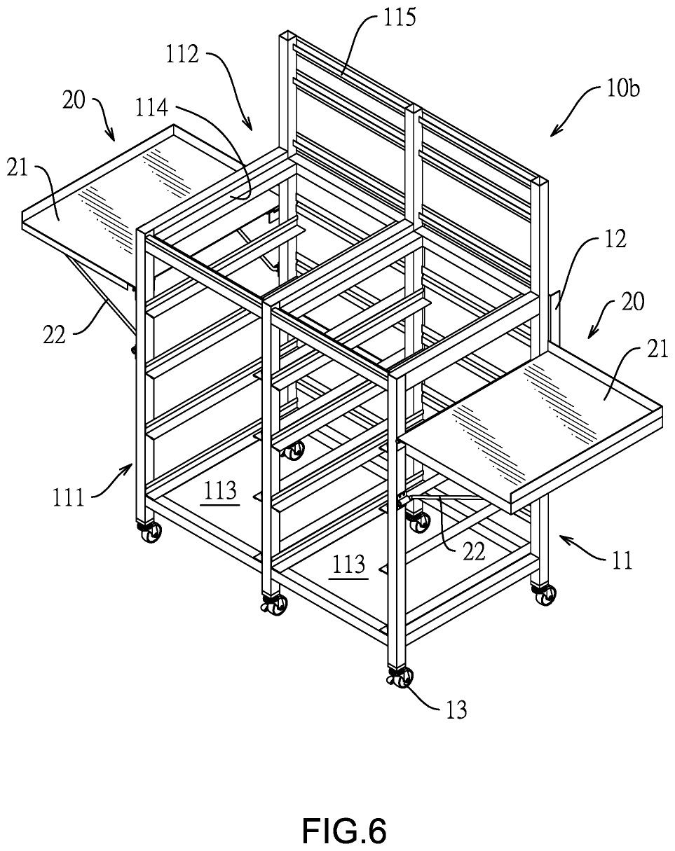

With reference to FIG. 6, in a second embodiment of the mobile kitchen cart assembly in accordance with the present invention, the cart body 11 of the cart 10b comprises multiple carrier portions 111 and multiple operational portions 112. The multiple carrier portions 111 are arranged side by side. The multiple operational portions 112 are respectively disposed above the multiple carrier portions 111.

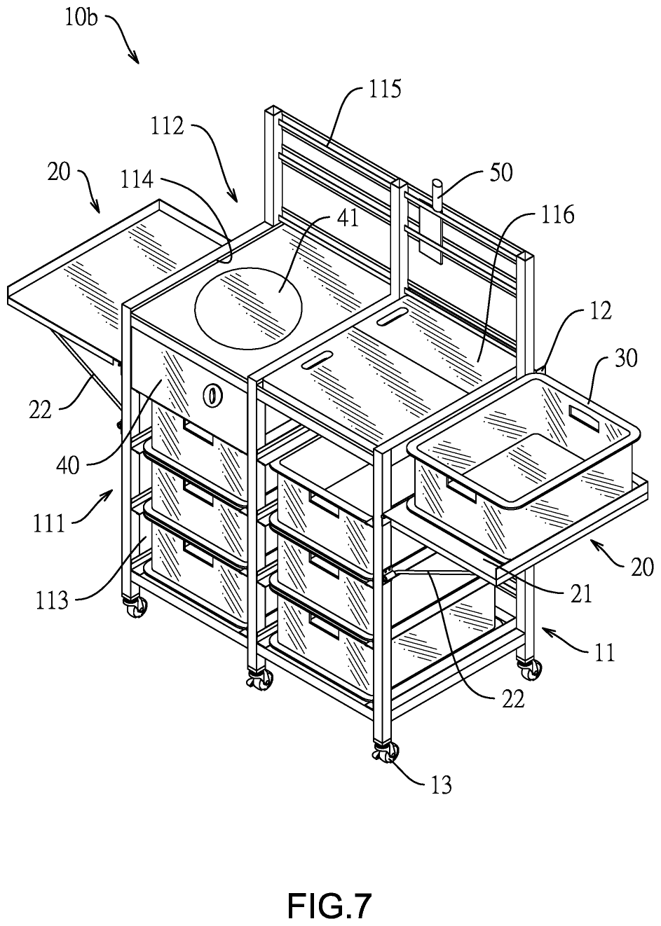

With reference to FIG. 7, the mobile kitchen cart assembly may comprise a heating device 40. The heating device 40 includes a heating zone 41 defined at a top thereof. The heating device 40 is placed in the accommodating space 113 of the carrier portion 111 of the cart body 11 and is located near a top of the carrier portion 111. The heating zone 41 is located at the upper opening 114 of the operational portion 112. As shown in FIG. 7, the heating device 40 may be placed in the accommodating space 113 of one of the multiple carrier portions 111 of the cart body 11, and the multiple chopping boards 116 may be placed in the upper opening 114 of the operational portion 112 adjacent to the heating device 40.

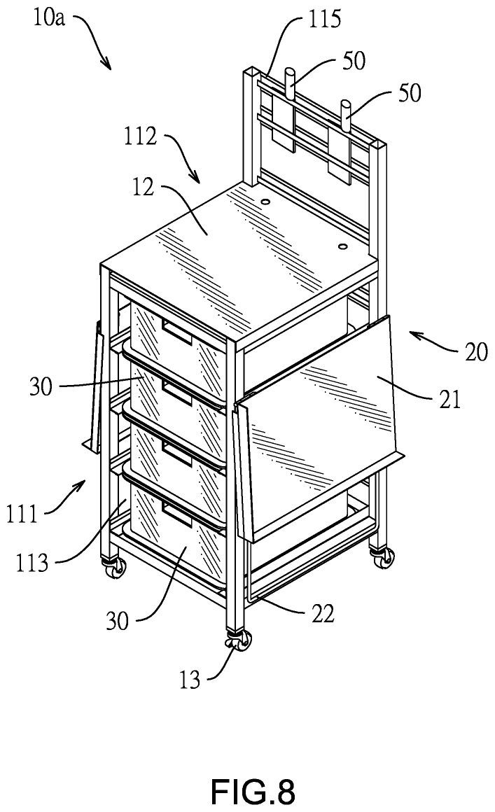

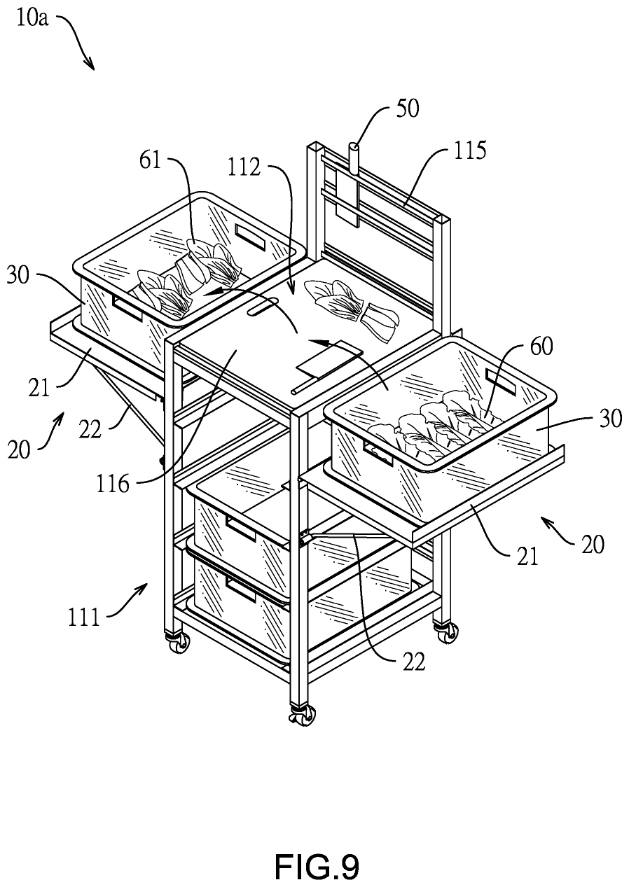

As shown in FIGS. 8 and 9, for example, the first embodiment of the mobile kitchen cart assembly in accordance with the present invention provides the kitchen staff with functions of conveniently carrying ingredients 60 and knives 50 and of conveniently processing ingredients 60. In addition, the supporting stands 20 can be optionally folded for storage to effectively decrease a storage space of the mobile kitchen cart assembly.

With reference to FIGS. 1 and 8, when the kitchen staff processes the ingredients such as dough, the cover plate 12 can be placed on the operational portion 112 to cover the upper opening 114 of the operational portion 112. The kitchen staff can knead the dough or roll-ping the dough on the cover plate 12.

With reference to FIGS. 1 and 9, when the kitchen staff prepares the ingredients 60 such as fruits and vegetables, the raw ingredients 60 are put into the storage boxes 30, and then the storage boxes 30 are put into the accommodating space 113 of the carrier portion 111. After that, the kitchen staff can push the mobile kitchen cart assembly with the raw ingredients 60 outside to a water source to wash the raw ingredients 60.

The cover plate 12 can be covered on the upper opening 114 of the operational portion 112 and the supporting stands 20 can be expanded to increase space for processing the ingredients 60. The kitchen staff can also put an empty one of the storage boxes 30 and a full one of the storage boxes 30 containing raw ingredients 60 on the supporting stand 20 and the cover plate 12 covered on the operational portion 112, respectively. The ingredients 60 can be washed and then put into the empty storage box 30.

When the ingredients 60 are chopped, the amount of and size of the chopping board 116 can be selected according to usage habits of the kitchen staff. With reference to FIGS. 4 and 9, the kitchen staff can chop the ingredients 60 with the sole chopping board 116. When the ingredients 60 are chopped, the kitchen staff can put the storage box 30 containing the ingredients 60 on the supporting stand 20 at one side of the cart body 11 and put the empty storage box 30 on the supporting stand 20 at the other side of the cart body 11. Therefore, the kitchen staff can directly fetch the ingredients 60 from the storage box 30, place the ingredients 60 on the chopping board 116, cut the ingredients 60 by one of the knives 50, and then put chopped ingredients 61 into the empty storage box 30.

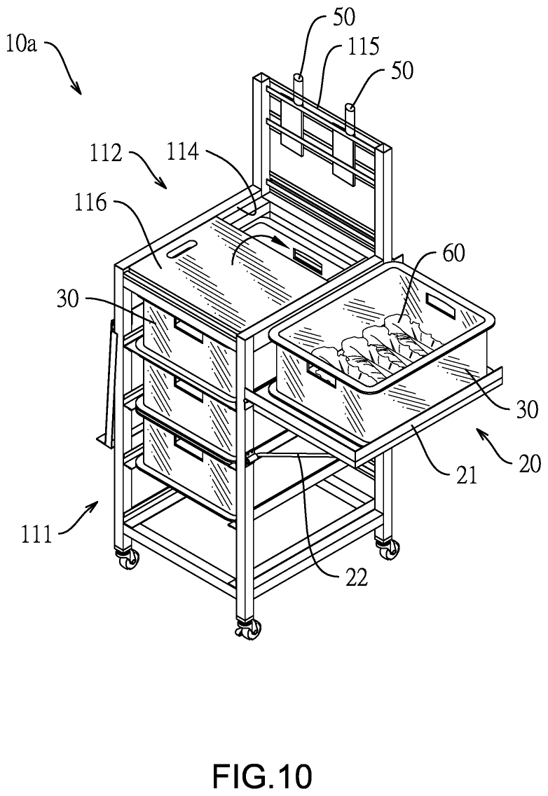

With reference to FIGS. 5 and 10, the kitchen staff can also choose the multiple chopping boards 116 according to usage habits of the kitchen staff. One of the chopping boards 116 inside the upper opening 114 of the operational portion 112 can be removed to make the upper opening 114 partially uncovered. The kitchen staff can put the storage box 30 containing the ingredients 60 on the supporting stand 20 at one side of the cart body 11 and place the empty storage box 30 into the accommodating space 113 below the upper opening 114. Therefore, the kitchen staff can directly fetch the ingredients 60 from the storage box 30, put the ingredients 60 on the chopping board 116, cut the ingredients 60 by one of the knives 50, and then sweep chopped ingredients 61 into the upper opening 114. The chopped ingredients 61 drop into the empty storage box 30 below the upper opening 114.

The mobile kitchen cart assembly can provide the kitchen staff with sufficient operational space for processing the ingredients 60 by the cover plate 12 covering the upper opening 114 of the operational portion 112 and the two expanded supporting stands 20. The kitchen staff can wash or chop the ingredients 60 on the supporting stands 20 or the cover plate 12. The ingredients 60 being washed or chopped can be placed in containers such as baskets and temporarily stored inside the carrier portion 111. Therefore, interference of the traffic flow for processing the ingredients 60 is reduced. The mobile kitchen cart assembly in accordance with the present invention promotes space efficiency accordingly.

Moreover, the kitchen staff can stand to process the ingredients 60 by the cart body 11, with a sufficient height, of the cart 10a, 10b. Therefore, the kitchen staff are protected from the injuries caused by improper postures.

Furthermore, the ingredients 60 can be stored in the carrier portion 111 of the cart body 11 of the mobile kitchen cart assembly in accordance with the present invention, the knife holder 115 is disposed to the rear of the operational portion 112 of the cart body 11 for holding the knives 50, and the casters 13 are disposed at the bottom of the cart body 11. Therefore, the kitchen staff can directly push the cart 10a, 10b to other places to process the ingredients 60. The kitchen staff can directly fetch the ingredients 60 stored inside the carrier portion 111 and take one of the knives 50 held on the knife holder 115 to chop the ingredients 60. Accordingly, the mobile kitchen cart assembly in accordance with the present invention can be moved to a proper position according to the kitchen staff's demands. The ingredients 60 can be carried by and processed on the mobile kitchen cart assembly at a proper place. The mobile kitchen cart assembly in accordance with the present invention has a good maneuverability.

In addition, the mobile kitchen cart assembly can be selectively equipped with the heating device 40, so the kitchen staff can also put cookware with the chopped ingredients 61 at the heating zone 41 for cooking.

In summary, the mobile kitchen cart assembly in accordance with the present invention can provide sufficient operational space and a countertop with a suitable height for the kitchen staff by the arrangement of the cart body 11 of the cart 10a, 10b with the cover plate 12, and the two supporting stands 20. During processing of the ingredients 60, the kitchen staff is protected from being injured due to prolonged poor postures. In addition, with the arrangement of the knife holder 115 at the rear of the operational portion 112 of the cart body 11 for holding the knives 50 and the carrier portion 111 for carrying the ingredients 60, and the casters 13 disposed to the bottom of the cart body 11, the mobile kitchen cart assembly in accordance with the present invention provides good maneuverability.

What is claimed is:

1. A mobile kitchen cart assembly comprising:
a cart including:
a cart body including:
a carrier portion having
an accommodating space with a front opening facing toward a front of the cart body; and
an operational portion located above the carrier portion and having
an upper opening communicating with the accommodating space; and
a knife holder located at a rear of the operational portion;
a cover plate detachably disposed on and covering the upper opening of the operational portion; and
multiple casters disposed at a bottom of the cart body; and
two supporting stands respectively disposed at two sides of the cart body of the cart, each of the two supporting stands including:
a supporting plate being foldable and pivotally connected to the cart body of the cart; and
a supporting element being foldable, pivotally connected to the cart body of the cart, and connected to the supporting plate of the supporting stand to support the supporting plate in a horizontally expanding position.

2. The mobile kitchen cart assembly as claimed in claim 1, wherein
the mobile kitchen cart assembly comprises a chopping board detachably disposed in the upper opening of the operational portion;
multiple hangers are disposed on and protrude from an upper section of a rear of the cart body; and
the cover plate is configured to cover the chopping board and be hung at the rear of the cart body via the multiple hangers.

3. The mobile kitchen cart assembly as claimed in claim 1, wherein
the mobile kitchen cart assembly comprises two chopping boards detachably disposed in the upper opening of the operational portion and arranged side by side;
multiple hangers are disposed on and protrude from an upper section of a rear of the cart body; and
the cover plate is configured to cover the two chopping boards and be hung at the rear of the cart body via the multiple hangers.

4. The mobile kitchen cart assembly as claimed in claim 1, wherein the mobile kitchen cart assembly comprises multiple storage boxes configured to be stored in the accommodating space of the carrier portion of the cart body.

5. The mobile kitchen cart assembly as claimed in claim 2, wherein the mobile kitchen cart assembly comprises multiple storage boxes configured to be stored in the accommodating space of the carrier portion of the cart body.

6. The mobile kitchen cart assembly as claimed in claim 3, wherein the mobile kitchen cart assembly comprises multiple storage boxes configured to be stored in the accommodating space of the carrier portion of the cart body.

7. The mobile kitchen cart assembly as claimed in claim 1, wherein
the cart body comprises multiple said carrier portions arranged side by side and multiple said operational portions respectively disposed above the multiple carrier portions.

8. The mobile kitchen cart assembly as claimed in claim 2, wherein
the cart body comprises multiple said carrier portions arranged side by side and multiple said operational portions respectively disposed above the multiple carrier portions.

9. The mobile kitchen cart assembly as claimed in claim 3, wherein
the cart body comprises multiple said carrier portions arranged side by side and multiple said operational portions respectively disposed above the multiple carrier portions.

10. The mobile kitchen cart assembly as claimed in claim 4, wherein
the cart body comprises multiple said carrier portions arranged side by side and multiple said operational portions respectively disposed above the multiple carrier portions.

11. The mobile kitchen cart assembly as claimed in claim 5, wherein
the cart body comprises multiple said carrier portions arranged side by side and multiple said operational portions respectively disposed above the multiple carrier portions.

12. The mobile kitchen cart assembly as claimed in claim 6, wherein
the cart body comprises multiple said carrier portions arranged side by side and multiple said operational portions respectively disposed above the multiple carrier portions.

13. The mobile kitchen cart assembly as claimed in claim 1, wherein the mobile kitchen cart assembly comprises a heating device placed in the accommodating space of the carrier portion of the cart body and having a heating zone located at the upper opening of the operational portion.

14. The mobile kitchen cart assembly as claimed in claim 4, wherein the mobile kitchen cart assembly comprises a heating device placed in the accommodating space of the carrier portion of the cart body and having a heating zone located at the upper opening of the operational portion.

15. The mobile kitchen cart assembly as claimed in claim 7, wherein the mobile kitchen cart assembly comprises a heating device placed in the accommodating space of one of the multiple carrier portions of the cart body and having a heating zone located at the upper opening of one of the multiple operational portions.

16. The mobile kitchen cart assembly as claimed in claim 8, wherein the mobile kitchen cart assembly comprises a heating device placed in the accommodating space of one of the multiple carrier portions of the cart body and having a heating zone located at the upper opening of one of the multiple operational portions.

17. The mobile kitchen cart assembly as claimed in claim 9, wherein the mobile kitchen cart assembly comprises a heating device placed in the accommodating space of one of the multiple carrier portions of the cart body and having a heating zone located at the upper opening of one of the multiple operational portions.

18. The mobile kitchen cart assembly as claimed in claim 10, wherein the mobile kitchen cart assembly comprises a heating device placed in the accommodating space of one of the multiple carrier portions of the cart body and having a heating zone located at the upper opening of one of the multiple operational portions.

19. The mobile kitchen cart assembly as claimed in claim 11, wherein the mobile kitchen cart assembly comprises a heating device placed in the accommodating space of one of the multiple carrier portions of the cart body and having a heating zone located at the upper opening of one of the multiple operational portions.

20. The mobile kitchen cart assembly as claimed in claim 12, wherein the mobile kitchen cart assembly comprises a heating device placed in the accommodating space of one of the multiple carrier portions of the cart body and having a heating zone located at the upper opening of one of the multiple operational portions.
